(19) United States
(12) Patent Application Publication
(10) Pub. No.: US 2020/0233634 A1
(43) Pub. Date: Jul. 23, 2020

(54) USB-TYPE BLUETOOTH ADAPTOR FOR SMARTPHONE

(71) Applicant: BUJEON CO., LTD., Ansan-si (KR)

(72) Inventors: Donghyun SEO, Ansan-si (KR); Hyoukkyu KWON, Hwaseong-si (KR)

(21) Appl. No.: 16/742,953

(22) Filed: Jan. 15, 2020

(30) Foreign Application Priority Data
Jan. 18, 2019 (KR) 10-2019-0006752

(51) Int. Cl. G06F 3/16; H04W 4/80; H04M 1/725; H04R 3/00

(52) U.S. Cl. CPC G06F 3/162; H04W 4/80; H04R 2420/07; G06F 3/165; H04R 3/00; H04M 1/7253

(57) ABSTRACT

Disclosed herein is a universal serial bus (USB)-type Bluetooth adaptor for a smartphone. The USB-type Bluetooth adaptor includes: a USB-type connector configured to be connected to a smartphone and to receive power and data; a Bluetooth adaptor body coupled to the USB-type connector and configured to contain a digital signal processor (DSP) therein; and a connector connected to the Bluetooth adaptor body and configured to be coupled to an external microphone. The DSP includes a digital to analog converter (DAC), a decoder, a mixer, and a Bluetooth transmission module. The source sound output by the smartphone and the external voice signal received through the microphone of earphones are mixed together and played back through the speaker.

### CROSS-REFERENCE TO RELATED APPLICATION

This application claims the benefit of Korean Patent Application No. 10-2019-0006752 filed on Jan. 18, 2019, which is hereby incorporated by reference herein in its entirety.

### BACKGROUND

### 1. Technical Field

The present invention relates generally to a universal serial bus (USB)-type Bluetooth adaptor for a smartphone, and more specifically to a USB-type Bluetooth adaptor for a smartphone, in which a source sound capable of being played back in a smartphone can be mixed with a sound of a microphone provided in an adaptor and can be played back through a speaker as if a song were sung within a karaoke room through a Bluetooth feature connected to the adaptor.

### 2. Description of the Related Art

Recently, the functions and utilization of popularized smartphones have been gradually diversified so that DMB, music, moving images, movies, games, and the WiBro Internet can be easily used, beyond the level of simple telephones supporting only telephone calls.

In order to listen to music, earphones 2 are connected to a smartphone 1, as shown in FIG. 1. The earphones 2 include speaker units 3 configured to be inserted into the ears of a user and a cable 4 configured to connect the speaker units 3. An earphone jack 6 configured to connect to the smartphone 1 is provided at one end of the cable 4.

Accordingly, after the earphone jack 6 has been connected to the smartphone 1, music that is stored or played back in the smartphone 10 is listened to through the speaker units 3 of the earphones 2.

In addition, the smartphone 1 and a speaker 200 are separated, and music within the smartphone 1 may be listened to through the speaker 200 using Bluetooth communication 202.

Today a karaoke room can be easily found in the periphery of our living space. Such a karaoke room has been widely used long before. Such a karaoke room is basically equipped with a background music system configured to provide a corresponding background song when a user selects a desired song, a microphone configured to enable the user to sing a song to the accompaniment of the corresponding background song, and a speaker system configured to output vocal consonants collected through the microphone. Such a karaoke system is widely distributed to common private houses in addition to business establishments. Furthermore, a portable background music instrument in which portability and mobility are taken into consideration in such a karaoke system is also sold on the market. However, there is a problem in that a lot of pieces of equipment and a large space are required to construct the karaoke system.

Currently, many smartphones provide applications including karaoke background music systems. A user vocalizes using a microphone connected to a speaker in a wired or wireless way in order to listen to his or her voice while singing a song to the accompaniment of the source sound of the song using a smartphone. In this case, a problem arises in that a mixed sound is not listened to through a single source because an instrumental song generated from the smartphone and his or her own voice are output in parallel through substantially different sources.

Accordingly, if a USB-type Bluetooth adaptor for a smartphone is provided such that a user can sing a song anywhere and at any time when the user wants to sing a song while minimizing noise pollution for surrounding people and such that an instrumental song from a smartphone and a user's voice can be listened to without a sense of difference, this may be beneficially used for a variety of types of people, such as a person who frequently uses a karaoke room, a person who specializes in vocal music, and a person who wants to be a singer. To this end, the inventors have developed the present invention.

Korean Patent No. 10-0782379 discloses an FM transmitter for implementing a karaoke room through a radio by producing a music signal stored in a portable device and mixing the music signal with a user's vocal song. However, the patent has problems in that it is inconvenient to tune the channel frequency of a radio in order to use the radio other than a speaker and in that a natural sound in which music and a voice have been mixed together cannot be listened to because the FM transmitter does not include a sound field program, such as an equalizer.

### SUMMARY

The present invention has been conceived to overcome the above-described problems, and an object of the present invention is to provide a USB-type Bluetooth adaptor for a smartphone, in which a source sound capable of being played back in a smartphone and the sound of an external microphone, such as earphones, are mixed together and played back through a speaker using Bluetooth communication.

According to an aspect of the present invention, there is provided a universal serial bus (USB)-type Bluetooth adaptor for a smartphone, the USB-type Bluetooth adaptor including: a USB-type connector configured to be connected to a smartphone and to receive power and data; a Bluetooth adaptor body coupled to the USB-type connector and configured to contain a digital signal processor (DSP) therein; and a connector connected to the Bluetooth adaptor body and configured to be coupled to an external microphone; wherein the DSP includes: a digital to analog converter (DAC) configured to receive a source sound from the smartphone through the USB-type connector and to convert a digital signal into an analog signal; a decoder configured to decode the source sound received through the DAC; a mixer configured to receive the source sound of the smartphone from the DAC and an external voice signal through the connector and to mix the received source sound and the received external voice signal; and a Bluetooth transmission module configured to transmit the source sound and voice signal, mixed by the mixer, to an external speaker using Bluetooth communication; and wherein the source sound output by the smartphone and the external voice signal received through the microphone of earphones are mixed and played back through the speaker.

The DSP may further include an echo unit configured to assign an echo to the external voice signal received from the microphone.

The source sound received from the smartphone may include a source sound stored in the smartphone or a source sound capable of being played back in the smartphone through a web.

The DSP may further include an equalizer configured to correct the source sound of the smartphone and the external voice signal.

The DSP may further include memory.

A processing program used in the DSP may be contained in the memory.

A USB recognition program may be additionally contained in the memory.

The USB-type Bluetooth adaptor may be contained in the smartphone, and the smartphone may transmit the mixed signal to the speaker using Bluetooth communication.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a diagram illustrating a smartphone and earphones connected to the smartphone according to a conventional technology;

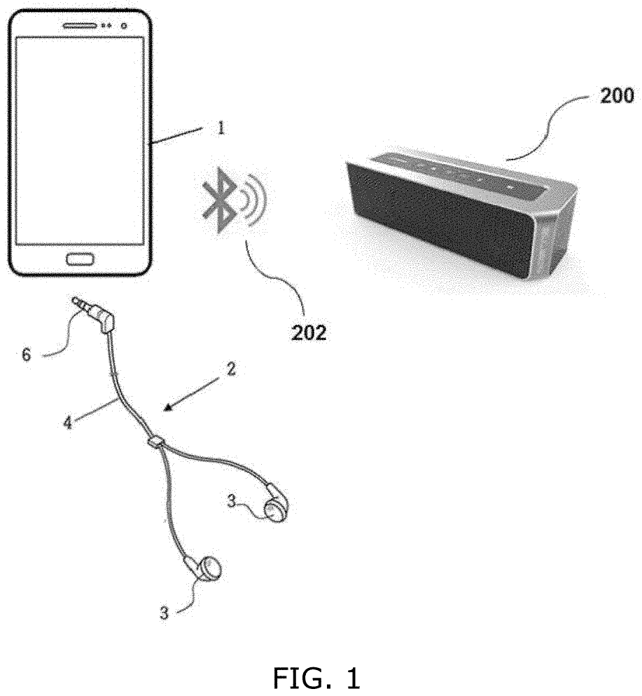

FIG. 2 is a diagram illustrating an overall configuration in which a USB-type Bluetooth adaptor for a smartphone according to an embodiment of the present invention is connected to a smartphone and a speaker;

FIG. 3 is a diagram illustrating a detailed configuration of the USB-type Bluetooth adaptor for a smartphone according to the embodiment of the present invention; and

FIG. 4 is a diagram illustrating the installation of an app on the screen of a smartphone for the purpose of implementing a karaoke room according to an embodiment of the present invention.

### DETAILED DESCRIPTION

A USB-type Bluetooth adaptor for a smartphone according to the present invention will be described in detail below with reference to the accompanying drawings.

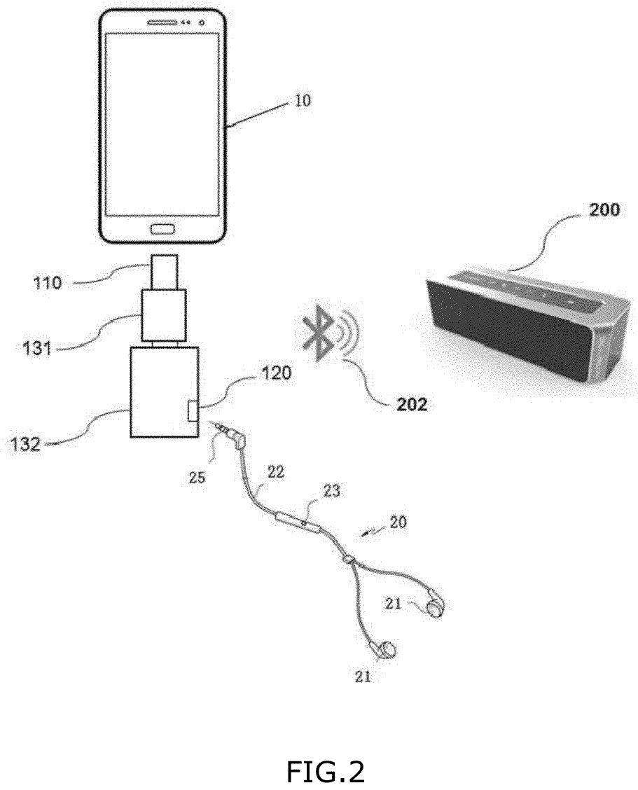

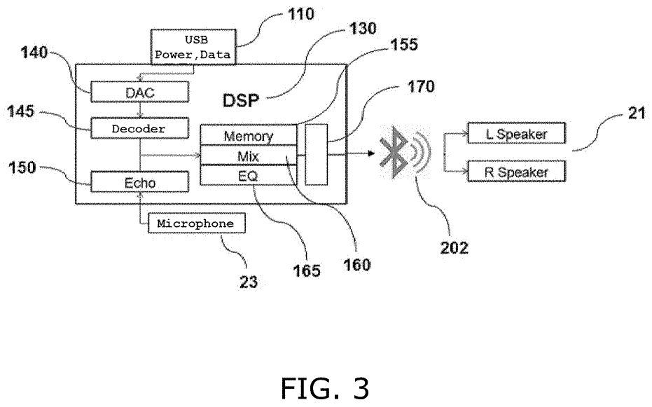

FIG. 2 is a diagram illustrating an overall configuration in which a USB-type Bluetooth adaptor for a smartphone according to an embodiment of the present invention is connected to a smartphone, earphones, and a speaker. FIG. 3 is a diagram illustrating a detailed configuration of the USB-type Bluetooth adaptor for a smartphone according to an embodiment of the present invention.

The USB-type Bluetooth adaptor for a smartphone according to the embodiment of the present invention includes a USB-type connector 110 configured to be connected to a smartphone 10 and to receive power and data, a Bluetooth adaptor body 132 coupled to the USB-type connector 110 and configured to contain a digital signal processor (DSP) 130 therein, and a connector 120 connected to the Bluetooth adaptor body 132 and configured to be coupled to an external microphone 23. The DSP 130 includes a digital to analog converter (DAC) 140 configured to receive a source sound from the smartphone 10 through the USB-type connector 110 and to convert a digital signal into an analog signal, a decoder 145 configured to decode the source sound received through the DAC 140, a mixer 160 configured to receive the source sound of the smartphone 10 from the DAC 140 and an external voice signal through the connector 120 and to mix the received source sound and the received external voice signal, and a Bluetooth transmission module 170 configured to transmit the source sound and voice signal, mixed by the mixer 160, to an external speaker 200 using Bluetooth communication 202. The source sound output by the smartphone 10 and the external voice signal received through the microphone 23 of earphones 20 are mixed together and played back through the speaker 200.

In the USB-type Bluetooth adaptor for a smartphone according to the embodiment of the present invention, as illustrated, a body part 131 is formed to surround the outside other than the connection front-end terminal of the USB-type connector 110. The connector 120 to which an external device, for example, the earphone jack 25 of the earphones 20, is connected is connected to the body part 132 of the Bluetooth adaptor.

The earphone jack 25 to be connected to the smartphone 10 is provided at the end of the cable 22 of the earphones 20 connected to the Bluetooth adaptor. The microphone 23 configured to receive an external voice and a control button (not illustrated) configured to control the playback of a source sound are provided in the middle part of the cable 22. Furthermore, the cable 22 is divided into two branches at its branch part. The cable branches are connected to speaker units 21 on the left and right sides.

The USB-type connector 110 formed on the top of the Bluetooth adaptor body 132 is coupled to the USB port of the smartphone 10. Accordingly, power and data including a source sound are input from the smartphone 10 to the Bluetooth adaptor.

The DSP 130 is contained in the Bluetooth adaptor body 132. The DSP 130 includes the DAC 140, the decoder 145, an echo unit 150, the mixer 160, an equalizer 165, memory 155, and the Bluetooth transmission module 170.

The DAC 140 functions to receive a source sound file, which is stored in the smartphone 10 or may be played back from the Web, as a digital signal and to convert the digital signal into an analog signal.

The decoder 145 functions to decode the source sound data converted into the analog signal by the DAC 140.

The echo unit 150 functions to assign an echo, such as a tremolo, a pitch or a vibrato, to an external voice signal received from the microphone 23 of the earphones 20. A voice output by the microphone 23 is converted into a ringing voice, and thus an effect may be achieved as if a song were sung in a karaoke room.

The mixer 160 receives a source sound of the smartphone 10 from the DAC 140 and an external voice signal from the echo unit 150, and mixes the received source sound and the received external voice signal.

The equalizer 165 functions to correct and process a source sound received from the smartphone 10 and an external voice signal received from the microphone 23. In an embodiment of the present invention, the equalizer 165 functions to change a source sound and a voice always and separately so that a user can produce a desired volume.

The memory 155 stores a USB recognition program for providing notification that the USB-type connector 110 is connected to the USB port of the smartphone 10 and connected to the smartphone 10 and a unique program for a processing method used in the DSP 130.

The source sound and voice signal mixed by the mixer 160 is transmitted to the speaker 200, including a Bluetooth receiver, through the Bluetooth transmission module 170 using Bluetooth communication 202.

The operation of the USB-type Bluetooth adaptor for a smartphone according to the present invention is described below.

As illustrated in FIG. 2, the USB-type connector 110 of the USB-type Bluetooth adaptor for a smartphone according to an embodiment of the present invention is connected to the USB port of the smartphone 10. Furthermore, the earphone jack 25 of the earphones 20 is connected to the connector 120 of the Bluetooth adaptor body 132.

A background song which is a source sound stored in the smartphone 10, or a source sound which may be listened to through the web is played back in the state in which the USB-type Bluetooth adaptor for a smartphone according to the embodiment of the present invention has been connected to the smartphone 10 and the earphones 20 as described above and the pair of speaker units 21 of the earphones 20 have been placed into both ears of a user.

Accordingly, the user can listen to the source sound, played back through the smartphone 10, through the speaker 200, and may directly sing a song to the accompaniment of a background song through the microphone 23 at the same time.

In this case, a voice, i.e., the song sung by the user, is input through the microphone 23. The input voice signal passes through the echo unit 150, and is mixed with the source sound, played back through the smartphone 10, in the mixer 160. Accordingly, the user can vividly listen to music and the voice at the same time because the mixed sound is transmitted to the speaker 200 through the Bluetooth transmission module 170.

As described above, the USB-type Bluetooth adaptor for a smartphone according to the embodiment of the present invention enables a user to listen to a source sound, played back through the smartphone 10, and his or her singing voice through the speaker 200 using Bluetooth communication. Accordingly, a karaoke function can be implemented even when a user does not individually visit a karaoke room.

Furthermore, the Bluetooth adaptor for a smartphone according to the embodiment of the present invention may be beneficially used to study a language in addition to the implementation of the karaoke function. For example, when an app for language study is executed and speaking is practiced through the smartphone 10, the Bluetooth adaptor for a smartphone may be beneficially used for language study because a user can listen to a foreigner's speaking played back in the smartphone 10 and his or her voice through the speaker 200.

As described above, the Bluetooth adaptor according to the embodiment of the present invention has advantages in that it can be used along with any earphones through wired connections with a smartphone and the earphones and can also be used along with any smartphone equipped with a USB port.

Although the foregoing description has been given in conjunction with the microphone 23 of the earphones 20, a user's voice and music may be mixed even in a phone because a microphone and a Bluetooth feature for music transmission are contained in the phone. Accordingly, any sound system capable of mixing sounds through the microphone and transmitting the mixed sound to a speaker using the Bluetooth feature, including a common microphone, may be used as the microphone 23.

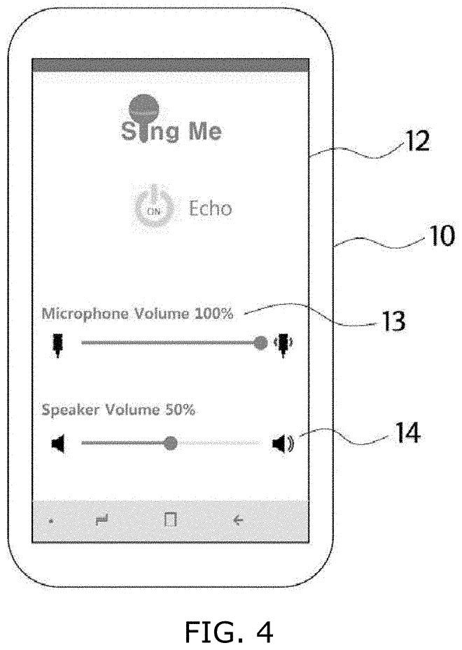

FIG. 4 is a diagram illustrating the installation of an app on the screen 12 of the smartphone 10 for the purpose of implementing a karaoke room according to an embodiment of the present invention.

As illustrated in the drawing, the intensity of a user's voice transmitted through the microphone 23 of the earphones 20 may be controlled through a microphone volume unit 13. The volume of the speaker 200 may be controlled through a speaker volume unit 14.

Furthermore, the speaker volume unit 14 may be separately installed in the speaker 200, and a source sound volume controller configured to control the sound of music that is being played back may also be installed in the speaker 200. Accordingly, various sounds can be further harmonized and listened to through the speaker 200 because the volumes of music and a voice can be controlled in the smartphone 10 at the same time.

As described above, the present invention provides the USB-type Bluetooth adaptor for a smartphone, in which a source sound which may be played back in a smartphone is mixed with an external voice signal received from the microphone of earphones and may be played back through a speaker using Bluetooth communication.

Although the specific embodiments of the present invention have been disclosed for illustrative purposes, those skilled in the art will appreciate that various modifications and alterations may be made without departing from the scope and spirit of the invention as disclosed in the attached claims.

What is claimed is:

1. A universal serial bus (USB)-type Bluetooth adaptor for a smartphone, the USB-type Bluetooth adaptor comprising:
a USB-type connector configured to be connected to a smartphone and to receive power and data;
a Bluetooth adaptor body coupled to the USB-type connector and configured to contain a digital signal processor (DSP) therein; and
a connector connected to the Bluetooth adaptor body and configured to be coupled to an external microphone;
wherein the DSP comprises:
a digital to analog converter (DAC) configured to receive a source sound from the smartphone through the USB-type connector and to convert a digital signal into an analog signal;
a decoder configured to decode the source sound received through the DAC;
a mixer configured to receive the source sound of the smartphone from the DAC and an external voice signal through the connector and to mix the received source sound and the received external voice signal; and
a Bluetooth transmission module configured to transmit the source sound and voice signal, mixed by the mixer, to an external speaker using Bluetooth communication; and
wherein the source sound output by the smartphone and the external voice signal received through the microphone of earphones are mixed together and played back through the speaker.

2. The USB-type Bluetooth adaptor of claim 1, wherein the DSP further comprises an echo unit configured to assign an echo to the external voice signal received from the microphone.

3. The USB-type Bluetooth adaptor of claim 1, wherein the source sound received from the smartphone comprises a source sound stored in the smartphone or a source sound capable of being played back in the smartphone through a web.

4. The USB-type Bluetooth adaptor of claim 1, wherein the DSP further comprises an equalizer configured to correct the source sound of the smartphone and the external voice signal.

5. The USB-type Bluetooth adaptor of claim 1, wherein the DSP further comprises memory.

6. The USB-type Bluetooth adaptor of claim 5, wherein a processing program used in the DSP is contained in the memory.

7. The USB-type Bluetooth adaptor of claim 6, wherein a USB recognition program is additionally contained in the memory.

8. The USB-type Bluetooth adaptor of claim 1, wherein:
the USB-type Bluetooth adaptor is contained in the smartphone; and
the smartphone transmits the mixed signal to the speaker using Bluetooth communication.
